(19) United States
(12) Patent Application Publication
(10) Pub. No.: US 2020/0082486 A1
(43) Pub. Date: Mar. 12, 2020

(54) DATA ANALYTICS TO IDENTIFY POTENTIAL PURCHASES OF EXPLOSIVE CHEMICAL PRECURSORS

(71) Applicant: International Business Machines Corporation, Armonk, NY (US)

(72) Inventors: Joseph KUCZYNSKI, North Port, FL (US); Sarah K. CZAPLEWSKI-CAMPBELL, Rochester, MN (US); Melissa K. MILLER, Research Triangle Park, NC (US); Rebecca MORONES, Berthoud, CO (US); Jonathan JACKSON, Cedar Grove, NC (US)

(21) Appl. No.: 16/123,599

(22) Filed: Sep. 6, 2018

(51) Int. Cl. G06Q 50/26; G06Q 50/00; G06K 9/00

(52) U.S. Cl. CPC G06Q 50/265; G06K 9/00288; G06Q 50/01

(57) ABSTRACT

Techniques for purchase analytics are provided. Purchase data is received, where the purchase data indicates a first item. It is determined that the purchase data corresponds to a purchase made by a first individual, and that the first item is included in a predefined list of reactants. One or more social media platforms are analyzed to identify a plurality of other individuals that have a relationship with the first individual. It is determined that at least one of the plurality of other individual has purchased a second item that is included in the predefined list of reactants. Upon determining that the first item and the second item meet a predefined combination, a suspicion metric is assigned to the first individual. Finally, upon determining that the suspicion metric exceeds a predefined threshold, an alert is generated, wherein the alert includes an indication of the first individual and the at least one other individual.

### BACKGROUND

The present invention relates to data analytics, and more specifically, to processing and analyzing data to identify suspicious purchases.

Improvised explosive devices (IEDs) have seen increasing use in recent years. Frequently, as more traditional explosives become harder to obtain, bomb makers utilize relatively common chemical precursors. Unlike other some substances, these chemical reactants typically have many perfectly legitimate uses. Further, in many cases, the reactants are available in virtually any store, preventing comprehensive tracking or registration of the products. Some precursors for illicit materials are tracked and highly controlled, and their purchase is often registered and monitored. However, explosive precursors (such as acetone, hydrogen peroxide, and the like) are extremely common, have a wide variety of ordinary uses, and are typically unmonitored.

### SUMMARY

According to one embodiment of the present disclosure, a method is provided. The method includes receiving first purchase data, wherein the first purchase data indicates a first item. The method further includes determining that the first purchase data corresponds to a purchase made by a first individual, and determining that the first item is included in a predefined list of reactants. Additionally, the method includes analyzing, by operation of one or more computer processors, one or more social media platforms to identify a plurality of other individuals that have a relationship with the first individual. The method also includes determining that at least one of the plurality of other individual has purchased a second item that is included in the predefined list of reactants. Upon determining that the first item and the second item meet a predefined combination, the method includes assigning a first suspicion metric to the first individual. Finally, upon determining that the first suspicion metric exceeds a predefined threshold, the method includes generating an alert, by operation of one or more computer processors, wherein the alert includes an indication of the first individual and the at least one other individual.

According to a second embodiment of the present disclosure, a computer program product is provided. The computer program product includes a computer-readable storage medium having computer-readable program code embodied therewith, the computer-readable program code executable by one or more computer processors to perform an operation. The operation includes receiving first purchase data, wherein the first purchase data indicates a first item. The operation further includes determining that the first purchase data corresponds to a purchase made by a first individual, and determining that the first item is included in a predefined list of reactants. Additionally, the operation includes analyzing one or more social media platforms to identify a plurality of other individuals that have a relationship with the first individual. The operation also includes determining that at least one of the plurality of other individual has purchased a second item that is included in the predefined list of reactants. Upon determining that the first item and the second item meet a predefined combination, the operation includes assigning a first suspicion metric to the first individual. Finally, upon determining that the first suspicion metric exceeds a predefined threshold, the operation includes generating an alert, wherein the alert includes an indication of the first individual and the at least one other individual.

According to a third embodiment of the present disclosure, a system is provided. The system includes one or more computer processors, and a memory containing a program which when executed by the one or more computer processors performs an operation. The operation includes receiving first purchase data, wherein the first purchase data indicates a first item. The operation further includes determining that the first purchase data corresponds to a purchase made by a first individual, and determining that the first item is included in a predefined list of reactants. Additionally, the operation includes analyzing one or more social media platforms to identify a plurality of other individuals that have a relationship with the first individual. The operation also includes determining that at least one of the plurality of other individual has purchased a second item that is included in the predefined list of reactants. Upon determining that the first item and the second item meet a predefined combination, the operation includes assigning a first suspicion metric to the first individual. Finally, upon determining that the first suspicion metric exceeds a predefined threshold, the operation includes generating an alert, wherein the alert includes an indication of the first individual and the at least one other individual.

### BRIEF DESCRIPTION OF THE SEVERAL VIEWS OF THE DRAWINGS

FIG. 1 illustrates a system configured to perform data analytics to identify suspicious purchases, according to one embodiment disclosed herein.

FIG. 2 is a block diagram of a data analytics device, according to one embodiment disclosed herein.

FIG. 3 is a flow chart illustrating a method of identifying and flagging suspicious purchases using data analytics, according to one embodiment disclosed herein.

FIG. 4 is a flow chart illustrating a method of identifying and flagging suspicious purchases using data analytics, according to one embodiment disclosed herein.

FIG. 5 is a flow chart illustrating a method of performing data analytics on purchase records to identify suspicious purchases, according to one embodiment disclosed herein.

FIG. 6 is a flow chart illustrating a method of performing data analytics to evaluate purchase history, according to one embodiment disclosed herein.

FIG. 7 is a flow chart illustrating a method of identifying and flagging suspicious purchases using data analytics, according to one embodiment disclosed herein.

### DETAILED DESCRIPTION

Embodiments of the present disclosure provide techniques for utilizing data analytics to identify suspicious purchases of otherwise innocuous materials which may be used to manufacture illicit or illegal substances or devices. For example, in one embodiment, suspicious purchases that include precursors for explosives are identified and flagged. For example, triacetone triperoxide (TATP), an explosive commonly used by terrorists, may be created utilizing various amounts of acetone, hydrogen peroxide, sulfuric acid, and other reactants. These reactants are commonly available in many stores, and have a large number of legitimate uses, such as paint thinner, nail polish remover, disinfectants, antiseptics, fertilizers, drain cleaner, and the like. As such, it is difficult or impossible to implement wide-scale licensing or monitoring of such products. Although explosives are used herein as examples, embodiments of the present disclosure can readily be applied to identify any suspicious purchases, where multiple different reactants or precursors may be purchased by any number of individuals, across any period of time, and in various volumes. Further, as used herein, a reactant, reagent, precursor, and the like are intended to refer to any item, compound, mixture, chemical, device, and the like which can be used to facilitate the creation of a predefined combination (e.g., an illegal, illicit, or dangerous substance or device).

Embodiments of the present disclosure provide specific data analytics methodologies to monitor purchases and flag suspicious or potentially dangerous patterns. In some embodiments of the present disclosure, a risk factor or suspicion metric is generated to quantify the level of risk or suspicion for a purchase or individual. In embodiments, this suspicion metric can be influenced by a variety of factors, including other individuals with which the index or target individual is associated, the purchase history of the individual's associates, purchase history of the target individual, attributes of the target individual and their associates, and the like.

In an embodiment, if the suspicion metric for an individual, or for an individual purchase, exceeds a predefined threshold, an alert or flag is generated. Further action may then be warranted, depending on the degree of suspicion, the reactants involved, and the like. In some embodiments, additional monitoring may be applied to the suspicious individual. Similarly, in an embodiment, local or federal authorities may be notified of the suspicious patterns.

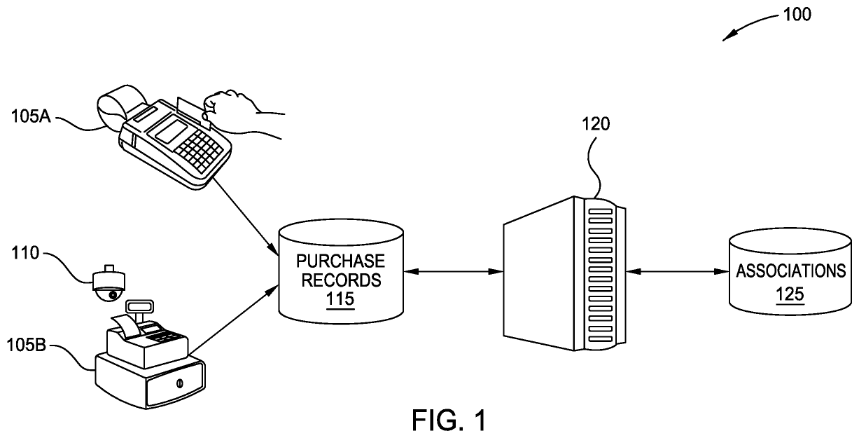

FIG. 1 illustrates a system 100 configured to perform data analytics to identify suspicious purchases, according to one embodiment disclosed herein. As illustrated, a Data Analytics Device 120 accesses data from a variety of sources, and performs data analytics to identify suspicious purchases, individuals, and groups. Although illustrated as a single device, in embodiments, the Data Analytics Device 120 may operate as a system of multiple devices, as a virtual workload or logical partition on one or more devices, and the like. In the illustrated embodiment, the Data Analytics Device 120 utilizes a data store of Associations 125 and Purchase Records 115. Although illustrated as external databases, in embodiments, one or both of the Purchase Records 115 and Associations 125 may be stored locally by the Data Analytics Device 120.

In the illustrated embodiment, the Associations 125 represent known relationships between individuals. In one embodiment, the Associations 125 include data provided by government or law enforcement regarding known associations or relationships. In some embodiments, the Associations 125 include relationships identified by parsing social media. For example, in one embodiment, the Data Analytics Device 120 accesses social media platforms to identify relationships between individuals based on their respective social media profiles. In an embodiment, each identified association or relationship is associated with a confidence value and/or a strength measure. In an embodiment, the confidence value indicates how confident the Data Analytics Device 120 is that the individuals are associated, while the strength measure indicates the strength of the relationship (e.g., how close the individuals appear to be). In an embodiment, the strength measure is affected by factors such as the length of the association, the degree of interaction, the type of interaction, and the like.

In various embodiments, the Data Analytics Device 120 utilizes a variety of factors retrieved from the social media platforms to identify relationships, as well as the strength of each relationship. For example, the Data Analytics Device 120 may determine whether individuals are connected or linked, whether they list each other as friends or acquaintances, whether they like or share each other's posts, and the like. In some embodiments, the Data Analytics Device 120 further determines how frequently the individuals interact, how long the individuals' have been associated, and the like. In one embodiment, the Data Analytics Device 120 also considers whether the individuals are members of the same group or like the same things, even if they do not directly interact. For example, even if two individuals are not directly connected the Data Analytics Device 120 may nevertheless identify an Association 115 if both individuals are listed as members of the same club, living in a similar region, having similar interests, and the like.

In some embodiments, the Data Analytics Device 120 also accesses one or more social media platforms to identify attributes of each individual. In an embodiment, such attributes may affect the suspiciousness of each purchase. For example, large purchases of fertilizer are not suspicious if the individual is a gardener or farmer. Similarly, frequent acetone purchases may be uneventful for a painter or owner of a nail salon. In embodiments, the attributes may include a job, career, or profession of the individual, hobbies of the individual, events or locations the individual has visited or will visit, and the like. These attributes may be explicitly defined or listed by the individual, or inferred based on other information. In one embodiment, natural language processing (NLP) may be applied to posts of the user to identify attributes. For example, if an individual posts about painting their home, or shares an article relating to gardening, the Data Analytics Device 120 may identify corresponding attributes.

In the illustrated embodiment, the Purchase Records 115 are created based on data retrieved from various Points of Sale 105A (POS). For example, as illustrated by POS 105A, an individual may use a credit card, debit card, rewards card, or other identifying information when purchasing items. In an embodiment, the Data Analytics Device 120 parses these Purchase Records 115 to identify items that each individual has purchased, when and where the purchase was made, the volume of each purchase, and the like.

In some embodiments, the Data Analytics Device 120 can also identify the individual associated with a given purchase even if the individual did not use an identifying card or information. For example, if the individual used cash, a gift card, or a stolen card, traditional Purchase Records 115 may be insufficient. In some embodiments, one or more POS 105B are associated with one or more Cameras 110. In such an embodiment, if an individual who made a purchase is not readily identifiable, the Data Analytics Device 120 can retrieve one or more images from these Cameras 110, and apply facial recognition technology to identify which individual made the purchase.

In embodiments, based on the Purchase Records 115, Associations 125, and other data, the Data Analytics Device 120 determines a level of suspicion for each purchase. In some embodiments, the suspicion metrics for one or more purchases are aggregated to determine an overall suspicion metric for the individual. Based on these suspicion metrics, the Data Analytics Device 120 can take further action including allocating increased monitoring for the individual, alerting a user or administrator, notifying law enforcement authorities, and the like.

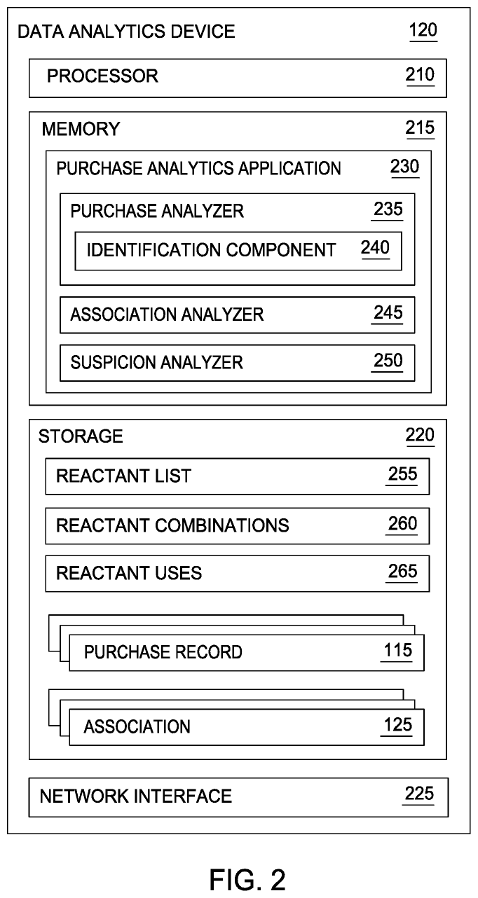

FIG. 2 is a block diagram of a Data Analytics Device 120, according to one embodiment disclosed herein. As illustrated, the Data Analytics Device 120 includes a Processor 210, a Memory 215, Storage 220, and a Network Interface 225. In the illustrated embodiment, Processor 210 retrieves and executes programming instructions stored in Memory 215 as well as stores and retrieves application data residing in Storage 220. Processor 210 is representative of a single CPU, multiple CPUs, a single CPU having multiple processing cores, and the like. Memory 215 is generally included to be representative of a random access memory. Storage 220 may be a disk drive or flash-based storage device, and may include fixed and/or removable storage devices, such as fixed disk drives, removable memory cards, or optical storage, network attached storage (NAS), or storage area-network (SAN). Through the Network Interface 225, the Data Analytics Device 120 may be communicatively coupled with other devices, such as external databases, POS 105, user or administrator terminals or computers, and the like.

In the illustrated embodiment, the Storage 220 includes a Reactant List 255, a list of known Reactant Combinations 260, a list of Reactant Uses 265, a number of Purchase Records 115, and a number of identified Associations 125. Although illustrated as residing in the Storage 220 of the Data Analytics Device 120, in embodiments, each of these data structures may reside in one or more other locations, such as Memory 215, or on one or more remote devices. Further, although illustrated as distinct data structures for ease of understanding, in embodiments, one or more of the Reactant List 255, list of known Reactant Combinations 260, and list of Reactant Uses 265 may be combined into a single data structure. For example, in one embodiment, a single database, table, list, or other data structure may include information about known reactants, combinations of reactants, and legitimate uses of reactants. Further, in some embodiments, the Associations 125 may be stored in the form of a record for each known individual, where the record also includes an indication of the corresponding Associations 125. In some embodiments, such a record may also include determined attributes for each individual, and/or purchases associated with the respective individual.

In the illustrated embodiment, the Reactant List 255 includes information about known chemical reactants. In an embodiment, a reactant is any item that can be used in the manufacture of a defined illicit, illegal, or dangerous substance or device. Examples of reactants include sulfuric acid, hydrogen peroxide, acetone, fertilizer, and the like. In an embodiment, the Reactant List 255 is predefined (such as by a subject matter expert), or retrieved from known literature. In the illustrated embodiment, the Reactant Combinations 260 include information about known combinations of reactants. In an embodiment, the Reactant List 255 is predefined by one or more users, or retrieved from known literature. For example, one known combination may be a particular explosive, and the reactants that are utilized to make the explosive can be enumerated or linked to this combination.

In some embodiments, the Reactant Combinations 260 also include information about legitimate combinations. In an embodiment, a legitimate combination includes a list of items (which may include one or more reactants) that, when purchased alongside a known reactant, make the purchase less suspicious. For example, for the reactant acetone, a legitimate combination may include paint, nail polish, painting supplies, and the like. In some embodiments, the Reactant Combinations 260 is stored in the same data structure as the Reactant List 255.

In the illustrated embodiment, the Reactant Uses 265 include information about legitimate uses for one or more reactants, as well as attributes of individuals that align with these uses. In an embodiment, the Reactant List 255 is predefined by one or more users, or retrieved from known literature. For example, for acetone, the Reactant Uses 265 may specify “painting/painter” as a legitimate use, and include other attributes, keywords, tags, and the like which can be used to identify individuals that fall within this defined legitimate use. In embodiments, the Reactant Uses 265 may be stored in the same data structure as the Reactant List 255 and/or Reactant Combinations 260.

As discussed above, in embodiments, the Purchase Records 115 include information about purchase history from one or more individuals. In some embodiments, each Purchase Record 115 corresponds to a particular purchase at a particular time. In other embodiments, each of the Purchase Records 115 correspond to a particular individual, regardless of the time or place of the purchase. Further, as discussed above, the Associations 125 include information about known relationships and associations between individuals. In embodiments, these Associations 115 can be identified through social media.

In the illustrated embodiment, the Memory 215 includes a Purchase Analytics Application 230. The Purchase Analytics Application 230 includes a Purchase Analyzer 235, an Association Analyzer 245, and a Suspicion Analyzer 250. Although illustrated as separate components, in embodiments, the functionality of each component may be combined or divided into one or more other components. Further, in embodiments, the various components may be implemented via software, hardware, or a combination of both hardware and software.

As illustrated, the Purchase Analyzer 235 includes an Identification Component 240. In the illustrated embodiment, the Purchase Analyzer 235 receives purchase data from one or more data stores or points of sale, identifies aspects of the purchase, and creates a Purchase Record 115. For example, the Purchase Analyzer 235 can use the Identification Component 240 to determine which individual(s) made the purchase, or were present when the purchase was made. In one embodiment, the Identification Component 240 utilizes records relating to, for example, credit card use, in order to provide this identification. In some embodiments, the Identification Component 240 utilizes one or more images captured by a camera at the point of sale, in order to perform facial recognition to identify the individual purchaser(s).

Further, in one embodiment, the Purchase Analyzer 235 populates the corresponding Purchase Record 115 with information relating to whether or not the purchase included any reactant(s) specified in the Reactant List 255, as well as the volume or amount of any such reactants. In some embodiments, the Purchase Analyzer 235 also determines, for each purchase, whether the purchase includes any items listed as a legitimate combination in the Reactant Combinations 260. In other embodiments, the Suspicion Analyzer 250 identifies these legitimate and dangerous combinations, as discussed in more detail below.

In the illustrated embodiment, the Association Analyzer 245 accesses one or more remote data sources, such as social media platforms, to identify Associations 125 or relationships between individuals. In an embodiment, the Association Analyzer 245 also determines a strength of each identified Association 125. For example, in one embodiment, the Association Analyzer 245 determines whether two or more individuals have interacted on social media, or whether they are members of the same groups. In one embodiment, individuals who have directly interacted may be assigned a first relationship strength, while users who are members of one or more of the same groups, but who have never interacted directly, may be assigned a relatively lower strength score. Further, in one embodiment, the Association Analyzer 245 determines the type of interactions (e.g., messaging, liking or sharing, and the like), as well as the frequency and duration of the interactions, to assign a corresponding strength to the identified Association 125.

In the illustrated embodiment, the Suspicion Analyzer 250 parses the Purchase Records 115 and Associations 125 for a target or index individual to determine a level of suspicion. For example, in one embodiment, the Suspicion Analyzer 250 analyzes the Purchase Records 115 to determine whether the individual has purchased one or more known reactants. In some embodiments, the Suspicion Analyzer 250 only considers Purchase Records 115 that correspond to a specified window of time. In some embodiments, this window of time includes a maximum age (e.g., a length of time preceding the current time). In one embodiment, the window of time varies based on the suspicion metric associated with the individual. For example, in one embodiment, the Suspicion Analyzer 250 generates a first suspicion metric for the individual based on a default length of time (e.g., purchases within the last 12 months). In such an embodiment, if this metric exceeds a specified threshold, the Suspicion Analyzer 250 can retrieve and analyze additional Purchase Records 115 from further into the past.

In some embodiments, the Suspicion Analyzer 250 determines the volume or amount of any reactant purchases. In embodiments, the Suspicion Analyzer 250 may limit this volume determination to the instant Purchase Record 115, or may be configured to aggregate multiple Purchase Records 115 within a predefined time window (e.g., within a week of the instant record). In such an embodiment, a higher volume or amount may yield a higher suspicion metric. In an embodiment, for each reactant purchase, the Suspicion Analyzer 250 determines whether any mitigating or exacerbating factors exist. In one embodiment, the Suspicion Analyzer 250 searches other Purchase Records 115 to identify reactants or legitimate items specified in the Reactant Combinations 260. In one embodiment, the Suspicion Analyzer 250 only considers Purchase Records 115 within a predefined time window from the index purchase.

For example, in one embodiment, if the Suspicion Analyzer 250 determines that the individual has purchased two or more reactants listed in a Reactant Combination 260, the Suspicion Analyzer 250 may assign a higher suspicion metric to the purchase and/or the individual. Similarly, if the Suspicion Analyzer 250 determines that the individual purchased mitigating items (such as paint brushes and paint, along with acetone), the Suspicion Analyzer 250 can assign a relatively lower suspicion metric.

In the illustrated embodiment, the Suspicion Analyzer 250 also evaluates the known Associations 125 of the individual, in order to assign a suspicion level. In one embodiment, the suspicion metric of an individual is based in part on the suspicion level of other individuals with which the index individual has a relationship. In an embodiment, the suspicion metric of each associate or colleague of the individual is weighted based on the strength of the identified Association 125. For example, if one related individual has a weak relationship with the target individual, the Suspicion Analyzer 250 may reduce the affect that the related individual has on the target individual's suspicion metric, as discussed in more detail below.

In some embodiments, in addition to analyzing the Purchase Records 115 of the target individual, the Suspicion Analyzer 250 also retrieves and analyzes Purchase Records 115 of one or more identified associates, based on the Associations 125. In some embodiments, the Suspicion Analyzer 250 only analyzes the Purchase Records 115 of associates that have a relationship strength exceeding a predefined threshold. In one embodiment, if a related individual purchased a complementary reactant to the reactant purchased by the target individual (as indicated in the Reactant Combinations 260), the Suspicion Analyzer 250 increases the suspicion metric of the target individual and/or the related individual. For example, if one person bought acetone, and a related individual purchased hydrogen peroxide, the Suspicion Analyzer 250 may tag them as suspicious transactions, and increment the suspicion metric(s) of the individuals. In some embodiments, the amount of change to the suspicion metric can be based in part on aspects such as the volume of reactants purchased, as well as the strength of their relationship. In some embodiments, the Suspicion Analyzer 250 may also consider the physical proximity of the individuals. For examples, individuals who have never been in the same state as each other may be less likely to share reactants for illegitimate purposes.

In some embodiments, the Suspicion Analyzer 250 also considers attributes of the target individual, to determine whether any attributes mitigate or explain the reactant purchase(s). In an embodiment, the Suspicion Analyzer 250 may identify legitimate Reactant Uses 265 for any reactants the individual purchased, and determine whether the individual has any attributes that align with such use. For example, if the individual purchased a large amount of acetone, but their attributes indicate they are a painter, the Suspicion Analyzer 250 may increment the suspicion metric less than if the individual lacked the attribute, or may refrain from increasing the suspicion metric at all.

In embodiments, the target individual can be selected in any number of ways. In one embodiment, a list of potential target individuals can be identified, such as by law enforcement, and the Data Analytics Device 120 can evaluate one or more of these potential targets. In some embodiments, the Data Analytics Device 120 can also be provided specific individuals to analyze. In one embodiment, the Purchase Analytics Application 230 identifies individuals based on purchase data received, and generates a suspicion metric for each identified individual. Regardless of the specific methodology used for selection, in embodiments, the Purchase Analytics Application 230 is configured to perform data analytics to identify suspicious patterns and purchases in a wide variety of data.

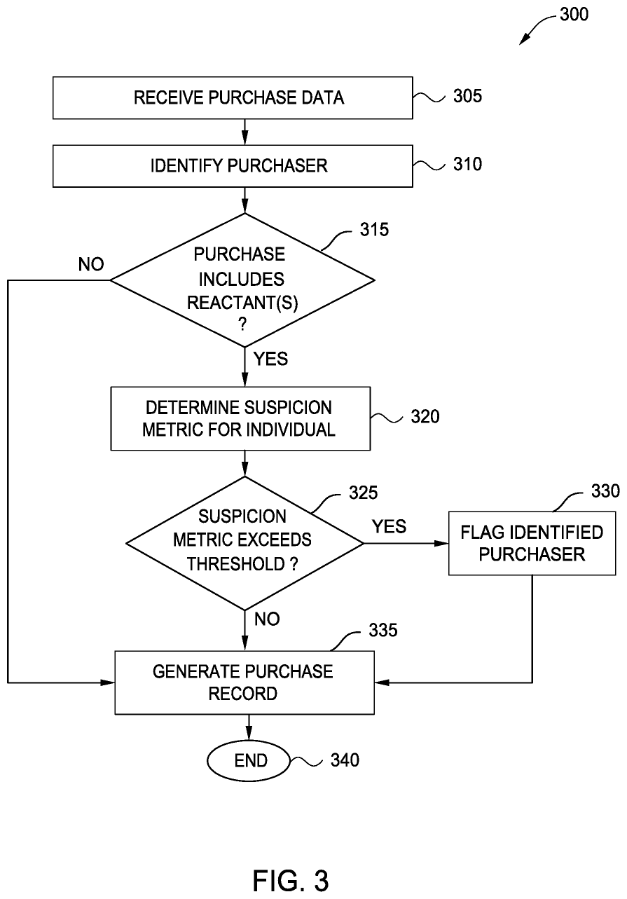

FIG. 3 is a flow chart illustrating a method 300 of identifying and flagging suspicious purchases using data analytics, according to one embodiment disclosed herein. In the illustrated embodiment, the method 300 begins at block 305, where the Purchase Analytics Application 230 receives purchase data. In an embodiment, the purchase data corresponds to a particular purchase, and can include information such as the time of the purchase, the item(s) purchased, the location of the purchase, and the like. In the illustrated embodiment, at block 310, the Purchase Analytics Application 230 identifies the individual who made the purchase. As discussed above, this may include accessing financial records (e.g., credit card records), using facial recognition, and the like.

The method 300 then proceeds to block 315, where the Purchase Analytics Application 230 determines whether there are any reactants in the purchase. In an embodiment, the Purchase Analytics Application 230 compares each purchased item to a predefined list of reactants to determine whether the purchase includes any such reactants. If the purchase does not include reactants, the method 300 proceeds to block 335, where the Purchase Analytics Application 230 generates a purchase record for the purchase. In embodiments, the purchase record can include information such as the item(s) purchased, the timing of the purchase, location of the purchase, the individual who made the purchase, and the like. In this way, the purchase data is transformed into a uniform and consistent data structure, a Purchase Record 115, for subsequent use.

If, however, the Purchase Analytics Application 230 determines, at block 315, that the purchase includes at least one reactant, the method 300 proceeds to block 320. At block 320, the Purchase Analytics Application 230 determines a suspicion metric for the identified individual and/or for the current purchase. In some embodiments, block 320 corresponds to updating or revising a suspicion metric for the first individual. For example, if a suspicion metric has already been generated for the individual (based on prior purchase data), the Purchase Analytics Application 230 can refine this suspicion metric based on how the present purchase affects it. Although not illustrated, in some embodiments, the Purchase Analytics Application 230 can determine or refine a suspicion metric for the individual, even if the present purchase does not contain any reactants. For example, if the individual purchased one or more reactants at a prior time, and subsequently purchased other items that explain a legitimate use or combination, the subsequent purchase can be analyzed to reduce the suspicion generated by the prior purchase.

Once the suspicion metric for the individual has been determined, the method 300 proceeds to block 325, where the Purchase Analytics Application 230 determines whether the suspicion metric exceeds a predefined threshold. If so, the method 300 continues to block 330, where the Purchase Analytics Application 230 flags the identified individual. In embodiments, this flag can trigger a variety of actions, such as increased or more frequent monitoring, notification of local authorities, and the like. In some embodiments, the action taken depends in part on the value of the suspicion measure. For example, upon exceeding a first threshold, monitoring may be increased. If the individual exceeds a second threshold, local authorities may be notified.

The method 300 then proceeds to block 335, where the Purchase Analytics Application 230 generates a purchase record for the purchase. Additionally, if the suspicion metric does not exceed the threshold, the method 300 continues to block 335 to generate a purchase record. In this way, as discussed above, the Purchase Analytics Application 230 can readily access the purchase data in a uniform format for subsequent processing. The method 300 then terminates at block 340.

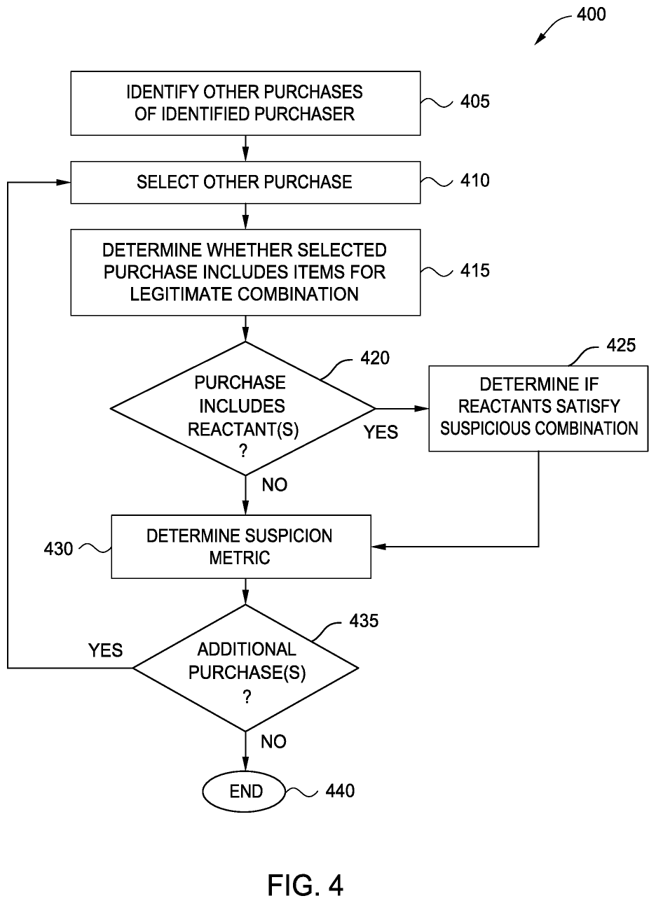

FIG. 4 is a flow chart illustrating a method 400 of identifying and flagging suspicious purchases using data analytics, according to one embodiment disclosed herein. In some embodiments, the method 400 is utilized to determine the suspicion metric for an individual. For example, in one embodiment, the method 400 is utilized at block 320 of FIG. 3. The method 400 begins at block 405, where the Purchase Analytics Application 230 identifies other purchases that are associated with the selected or identified purchaser (e.g., the individual identified at block 310 of FIG. 3). For example, in one embodiment, the Purchase Analytics Application 230 searches one or more data stores for Purchase Records 115 that are associated with the identified individual. In some embodiments, the Purchase Analytics Application 230 identifies other purchases that occurred within a predefined time period from the current time, or within a predefined time period from the time the original purchase (e.g., the one received in block 305 of FIG. 3) occurred. In some embodiments, the weight or impact of each purchase may be determined in part based on how much time elapsed between the purchases.

The method 400 then proceeds to block 410, where the Purchase Analytics Application 230 selects one of the identified purchase records. At block 415, the Purchase Analytics Application 230 determines whether the selected purchase record includes any items that mitigate the purchase of the reactant identified in the current purchase (e.g., the reactant identified in block 315 of FIG. 3). For example, as discussed above, in one embodiment the Purchase Analytics Application 230 accesses a predefined list of items that reduce suspicion in an identified reactant purchase (e.g., a purchase of gardening equipment, topsoil, and seeds reduces suspicion in a large fertilizer purchase). The method 400 then proceeds to block 420.

At block 420, the Purchase Analytics Application 230 determines whether the selected prior purchase includes any reactants. If not, the method 400 proceeds to block 430 where the Purchase Analytics Application 230 determines or refines the suspicion metric for the individual. If the selected purchase includes at least one additional reactant, the method 400 continues to block 425, where the Purchase Analytics Application 230 determines whether the identified reactants satisfy a predefined suspicious combination. For example, as discussed above, in one embodiment, the Purchase Analytics Application 230 accesses a predefined list of reactant combinations. In one embodiment, this list of reactant combinations includes predefined dangerous, illicit, illegal, or restricted substances or products (such as explosives), along with an indication as to any reactants or items that are used in the creation of the illicit substance. The method 400 then proceeds to block 430.

At block 430, the Purchase Analytics Application 230 determines or refines the suspicion metric of the individual. For example, if the selected prior purchase included an item that illustrates a legitimate use for the reactant identified in the current purchase being analyzed, the Purchase Analytics Application 230 may reduce the suspicion metric, or determine that the purchase of the reactant is not suspicious. Additionally, in an embodiment, if the Purchase Analytics Application 230 determines that the selected purchase includes an additional reactant that meets a defined example of a dangerous combination, the Purchase Analytics Application 230 increases the suspicion metric.

In one embodiment, the magnitude of the change in the suspicion metric is determined based on factors including the volume or amount of reactants purchased, the ratio between the reactants (e.g., whether the amount of each reactant aligns with a defined ratio for the dangerous combination), a predefined level of risk or suspiciousness associated with one or more of the purchased reactants, a predefined level of risk or suspiciousness associated with the identified combination of reactants, and the like. In this way, an updated or refined suspicion metric can be generated based on the selected prior purchase. For example, if the combination and/or reactants are predefined as particularly dangerous, or purchased in large amounts, the Purchase Analytics Application 230 may assign a relatively higher suspicion.

The method 400 then proceeds to block 435, where the Purchase Analytics Application 230 determines whether there are additional purchases associated with the individual which are yet to be analyzed. If so, the method 400 returns to block 410. Otherwise, the method terminates at block 440. Advantageously, the method 400 provides techniques to analyze any other purchases associated with the identified individual, in order to determine how suspicious the present purchase is. This context can lead to better suspicion determinations, as other purchases may make the current purchase more or less suspicious, depending on their content.

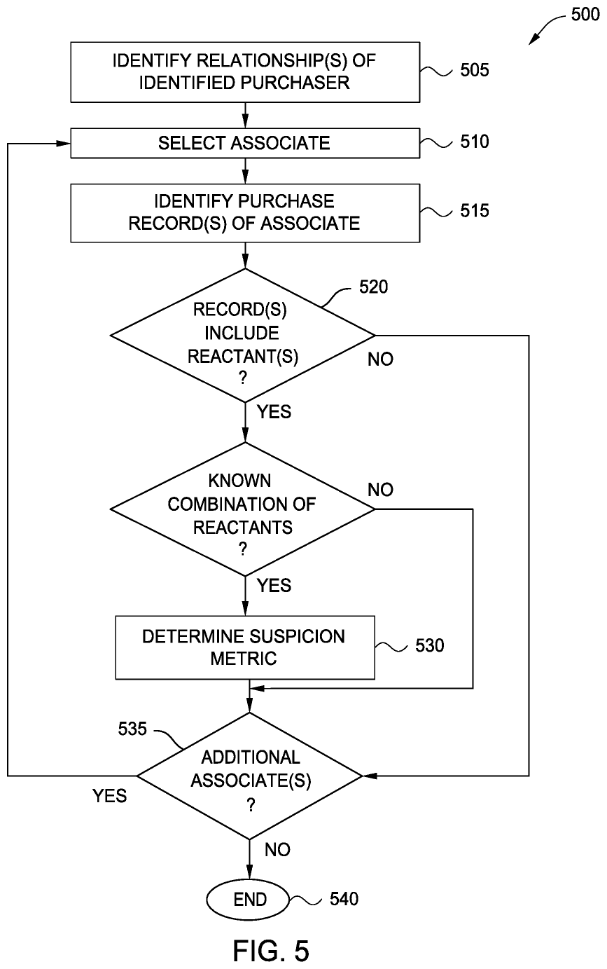

FIG. 5 is a flow chart illustrating a method 500 of performing data analytics on purchase records to identify suspicious purchases, according to one embodiment disclosed herein. In some embodiments, the method 500 is utilized to determine the suspicion metric for an individual. For example, in one embodiment, the method 500 is utilized at block 320 of FIG. 3. In an embodiment, the method 500 can be utilized in addition to the method 400. The method 500 begins at block 505, where the Purchase Analytics Application 230 identifies one or more relationships or Associations 125 of the identified purchaser. For example, as discussed above, in one embodiment, the Purchase Analytics Application 230 accesses one or more social media platforms to identify other individuals that have some relationship to the identified individual. In an embodiment, relationships can be identified based on direct interaction, as well as shared groups, interests, locations, and the like.

In some embodiments, the Purchase Analytics Application 230 may only identify associates that have a relationship strength exceeding a predefined threshold. Similarly, in some embodiments, the Purchase Analytics Application 230 only selects associates that are (or have been) within a predefined physical distance from each other. The method 500 then proceeds to block 510, where the Purchase Analytics Application 230 selects one of the identified associates. At block 515, the Purchase Analytics Application 230 identifies any purchase records associated with the selected associate. In one embodiment, the Purchase Analytics Application 230 only selects purchase records corresponding to purchases that occurred within a predefined time window, such as within a month of the purchase made by the identified individual that is being analyzed. In another embodiment, the weight or impact of a purchase may be reduced based on how much time elapsed between the purchases.

The method 500 then proceeds to block 520, where the Purchase Analytics Application 230 determines whether any of the identified purchases of the selected associate include any of the predefined reactants. If not, the method 500 proceeds to block 535. That is, in the illustrated embodiment, if the Purchase Analytics Application 230 determines that the selected associate has not purchased any reactants, the method 500 determines that it is unlikely that the selected associate is working with the identified individual to produce one of the predefined substances or devices using a combination of reactants.

If, however, the Purchase Analytics Application 230 determines that the selected associated has purchased at least one reactant, the method 500 proceeds to block 525, where the Purchase Analytics Application 230 determines whether the reactant(s) purchased by the selected associate are part of a defined combination of reactant combinations that can be used to produce a restricted substance or product. It may be non-suspicious if an individual A purchased a large amount of acetone, and an unrelated individual B purchased a corresponding amount of hydrogen peroxide. However, if the Purchase Analytics Application 230 identifies a relationship between the two, the Purchase Analytics Application 230 may determine that the combined purchases are at least somewhat suspicious, and increase the suspicion metric of one or both of the individuals.

If the Purchase Analytics Application 230 determines that there are no known combinations that include the reactant(s) purchased by the associate and the reactant(s) purchased by the identified individual, the method 500 proceeds to block 535, where the Purchase Analytics Application 230 determines whether there are additional associates to be analyzed. If such a combination is found, however, the method 500 proceeds to block 530. At block 530, the Purchase Analytics Application 230 determines or refines a suspicion metric associated with the identified individual, and/or the selected associate. For example, the suspicion metric can be increased because it was determined that the two individuals separately bought reactants, precursors, tools, and the like that, if combined, could be used to create an explosive device.

In embodiments, the magnitude of the suspicion metric (or of the change in the suspicion metric) can be determined based on a variety of factors, including the volume or amount of each reactant, a predefined risk factor associated with each reactant and/or with the combined product, whether there are additional required reactants that have not been purchased, how much time elapsed between the purchases, and the like. In some embodiments, the Purchase Analytics Application 230 also considers how much the amounts of each reactant differ from a predefined ratio (i.e., whether the amount of the second reactant is sufficient to fully react with the amount of the first reactant, based on the identified combination). For example, suppose a first individual purchased several gallons of acetone, and an identified associate (e.g., an individual with an identified relationship to the first individual) purchased a small container of hydrogen peroxide from a pharmacy. In such an embodiment, the Purchase Analytics Application 230 can determine that it is unlikely the two are working to manufacture explosives, because the ratio of the reactants does not align with the known ratio of reactants for such substances.

Once the suspicion metric is determined, the method 500 proceeds to block 535, where the Purchase Analytics Application 230 determines whether there are additional identified associates that are yet to be analyzed. If so, the method 500 returns to block 510, where the Purchase Analytics Application 230 selects the next associated individual. If all of the identified associates (e.g., the individuals that meet the predefined relationship criteria) have been considered, the method 500 terminates at block 540. In this way, embodiments of the present disclosure enable analytical consideration of other individuals that are or may be related to the target individual, in order to better determine a level of suspicion for the target individual.

In some embodiments, in addition to aggregating reactant amounts between purchases of a single individual, the Purchase Analytics Application 230 also aggregates reactant purchases between different individuals. For example, if a first associate of the index individual purchased a relatively small amount of a complementary reactant, the Purchase Analytics Application 230 may continue to analyze other associates to identify purchases of the same reactant(s). In this way, the Purchase Analytics Application 230 can determine whether, when aggregated, the amount of reactants purchased among all of the associated individuals is sufficient to trigger increased suspicion.

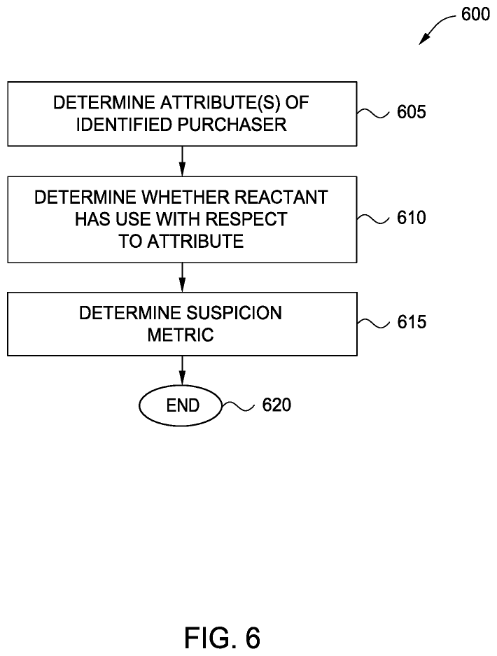

FIG. 6 is a flow chart illustrating a method 600 of performing data analytics to evaluate purchase history, according to one embodiment disclosed herein. In some embodiments, the method 600 is utilized to determine the suspicion metric for an individual. For example, in one embodiment, the method 600 is utilized at block 320 of FIG. 3. In an embodiment, the method 600 can be utilized in addition to the method 500 and/or the method 400. The method 600 begins at block 605, where the Purchase Analytics Application 230 determines one or more attributes of the identified purchaser (e.g., the individual identified in block 310 of FIG. 3).

In one embodiment, the Purchase Analytics Application 230 accesses one or more social media platforms to access an account of the identified individual. The Purchase Analytics Application 230 can then analyze information associated with the individual's social media account(s) to identify attributes of the purchaser. In some embodiments, the Purchase Analytics Application 230 utilizes one or more NLP models to analyze text associated with the profile(s). For example, the Purchase Analytics Application 230 can determine whether the individual has listed a job, profession, occupation, or hobby. Additionally, in some embodiments, the Purchase Analytics Application 230 analyzes posts and articles authored or shared by the individual, in order to determine attributes of the individual. For example, the purchaser may have posted an article relating to gardening, based on which the Purchase Analytics Application 230 can determine that the individual has a “gardening” attribute. In one embodiment, the Purchase Analytics Application 230 also generates a confidence value for each attribute, indicating a level of confidence that the individual possesses the attribute.

In some embodiments, the Purchase Analytics Application 230 also utilizes image recognition models to analyze pictures associated with the individual (e.g., posted by the individual, shared by the individual, and the like). Based on this analysis, the Purchase Analytics Application 230 can identify other attributes of the individual. Once attribute(s) of the individual have been determined, the method 600 proceeds to block 610, where the Purchase Analytics Application 230 determines whether the identified reactant that the individual purchased has a specific use with respect to the attribute(s). For example, in one embodiment, the Purchase Analytics Application 230 utilizes a predefined set of Reactant Uses 265. In one embodiment, the Reactant Uses 265 include categories of use or examples of legitimate use. In one embodiment, the Purchase Analytics Application 230 includes a list of reactants, along with attributes, keywords, and tags that align with or match with each reactant, indicating that individuals who possess the attribute may have a legitimate use for the reactant. For example, one such Reactant Use 265 may specify that acetone has legitimate use for painters, artists, and the like.

The method 600 then proceeds to block 615, where the Purchase Analytics Application 230 determines or refines the suspicion metric for the individual, based on the alignment between the individual's attributes and the purchased reactant(s). For example, if the individual has an attribute that matches with a legitimate use for the reactant, the suspicion metric may be low or zero. In some embodiments, the suspicion metric is based in part on the confidence of the respective attributes. For example, if an attribute would explain the purchase of a reactant, but the Purchase Analytics Application 230 is not confident that the individual possesses the attribute, the suspicion metric may be relatively higher than if the Purchase Analytics Application 230 was confident that the individual possessed the attribute. The method 600 then terminates at block 620.

In some embodiments, as discussed herein, a level of suspicion is determined for each purchase and/or for each individual. In some embodiments, each purchase is analyzed and categorized using a binary classification as either “suspicious” or “not suspicious.” For example, in one embodiment, if the individual has purchased complementary reactants within a predefined time period, this may be flagged as “suspicious.” In one embodiment, the Purchase Analytics Application 230 determines the number of “suspicious” flags associated with an individual, and flags the individual if the number of suspicious purchases exceeds a predefined threshold.

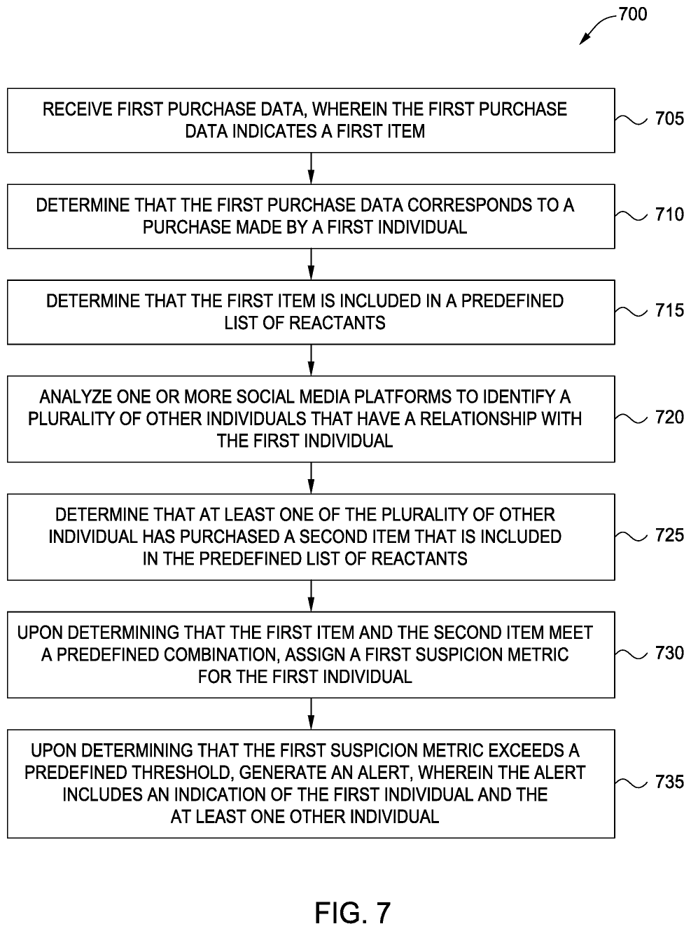

FIG. 7 is a flow chart illustrating a method 700 of identifying and flagging suspicious purchases using data analytics, according to one embodiment disclosed herein. The method 700 begins at block 705, where the Purchase Analytics Application 230 receives first purchase data, wherein the first purchase data indicates a first item. At block 710, the Purchase Analytics Application 230 determines that the first purchase data corresponds to a purchase made by a first individual, and at block 715, the Purchase Analytics Application 230 determines that the first item is included in a predefined list of reactants. The method 700 then continues to block 720, where the Purchase Analytics Application 230 analyzes one or more social media platforms to identify a plurality of other individuals that have a relationship with the first individual. At block 725, the Purchase Analytics Application 230 determines that at least one of the plurality of other individual has purchased a second item that is included in the predefined list of reactants. The method then proceeds to block 730 where, upon determining that the first item and the second item meet a predefined combination, the Purchase Analytics Application 230 assigns a first suspicion metric to the first individual. Finally, at block 735, upon determining that the first suspicion metric exceeds a predefined threshold, the Purchase Analytics Application 230 generates an alert, wherein the alert includes an indication of the first individual and the at least one other individual.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the Purchase Analytics Application 230) or related data available in the cloud. For example, the Purchase Analytics Application 230 could execute on a computing system in the cloud and perform data analytics on purchase data. In such a case, the Purchase Analytics Application 230 could ingest and process purchase data and store suspicion metrics at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
determining that a first item specified within a first purchase data is included in a predefined list of reactants, wherein the first purchase data corresponds to a purchase made by a first individual;
analyzing, by operation of one or more computer processors, one or more social media platforms to identify a plurality of other individuals that have a relationship with the first individual;
determining that at least one of the plurality of other individual has purchased a second item that is included in the predefined list of reactants;
upon determining that the first item and the second item meet a predefined combination, assigning a first suspicion metric to the first individual; and
upon determining that the first suspicion metric exceeds a predefined threshold, generating an alert, by operation of one or more computer processors, wherein the alert includes an indication of the first individual and the at least one other individual.

2. The method of claim 1, wherein determining that the first purchase data corresponds to the purchase made by the first individual comprises:
retrieving one or more images captured at a point-of-sale system at which the purchase was made; and
identifying the first individual based on analyzing the one or more images using at least on facial recognition model.

3. The method of claim 1, the method further comprising:
receiving second purchase data, wherein the second purchase data indicates a third item purchased by a third individual;
determining that the third item is included in the predefined list of reactants;
determining that the second purchase data is not suspicious; and
refraining from generating an alert indicating the third individual.

4. The method of claim 3, wherein determining that the second purchase data is not suspicious comprises:
analyzing purchase data associated with the third individual to identify one or more other items purchased by third individual; and
determining that the third item and at least one of the one or more other items are both included in a predefined legitimate combination.

5. The method of claim 3, wherein determining that the second purchase data is not suspicious comprises:
analyzing at least one social media platform associated with the third individual to identify a first attribute of the third individual; and
determining that the first attribute and the third item are both included in a predefined legitimate use.

6. The method of claim 1, wherein identifying the plurality of other individuals that have a known relationship with the first individual comprises evaluating at least one social media platform to identify at least one of: (i) a friendship or association between the first individual and at least one of the plurality of other individuals, or (ii) a group to which the first individual and at least one of the plurality of other individuals belong.

7. The method of claim 1, wherein the predefined combination is an explosive.

8. A computer program product comprising:
a computer-readable storage medium having computer-readable program code embodied therewith, the computer-readable program code executable by one or more computer processors to perform an operation comprising:
receiving first purchase data, wherein the first purchase data indicates a first item;
determining that the first purchase data corresponds to a purchase made by a first individual;
determining that the first item is included in a predefined list of reactants;
analyzing one or more social media platforms to identify a plurality of other individuals that have a relationship with the first individual;
determining that at least one of the plurality of other individual has purchased a second item that is included in the predefined list of reactants;
upon determining that the first item and the second item meet a predefined combination, assigning a first suspicion metric to the first individual; and
upon determining that the first suspicion metric exceeds a predefined threshold, generating an alert, wherein the alert includes an indication of the first individual and the at least one other individual.

9. The computer program product of claim 8, wherein determining that the first purchase data corresponds to the purchase made by the first individual comprises:
retrieving one or more images captured at a point-of-sale at which the purchase was made; and
identifying the first individual based on analyzing the one or more images using at least on facial recognition model.

10. The computer program product of claim 8, the operation further comprising:
receiving second purchase data, wherein the second purchase data indicates a third item purchased by a third individual;
determining that the third item is included in the predefined list of reactants;
determining that the second purchase data is not suspicious; and
refraining from generating an alert indicating the third individual.

11. The computer program product of claim 10, wherein determining that the second purchase data is not suspicious comprises:
analyzing purchase data associated with the third individual to identify one or more other items purchased by third individual; and
determining that the third item and at least one of the one or more other items are both included in a predefined legitimate combination.

12. The computer program product of claim 10, wherein determining that the second purchase data is not suspicious comprises:
analyzing at least one social media platform associated with the third individual to identify a first attribute of the third individual; and
determining that the first attribute and the third item are both included in a predefined legitimate use.

13. The computer program product of claim 8, wherein identifying the plurality of other individuals that have a known relationship with the first individual comprises evaluating at least one social media platform to identify at least one of: (i) a friendship or association between the first individual and at least one of the plurality of other individuals, or (ii) a group to which the first individual and at least one of the plurality of other individuals belong.

14. The computer program product of claim 8, wherein the predefined combination is an explosive.

15. A system comprising:
one or more computer processors; and
a memory containing a program which when executed by the one or more computer processors performs an operation, the operation comprising:
receiving first purchase data, wherein the first purchase data indicates a first item;
determining that the first purchase data corresponds to a purchase made by a first individual;
determining that the first item is included in a predefined list of reactants;
analyzing one or more social media platforms to identify a plurality of other individuals that have a relationship with the first individual;
determining that at least one of the plurality of other individual has purchased a second item that is included in the predefined list of reactants;
upon determining that the first item and the second item meet a predefined combination, assigning a first suspicion metric to the first individual; and
upon determining that the first suspicion metric exceeds a predefined threshold, generating an alert, wherein the alert includes an indication of the first individual and the at least one other individual.

16. The system of claim 15, wherein determining that the first purchase data corresponds to the purchase made by the first individual comprises:
retrieving one or more images captured at a point-of-sale at which the purchase was made; and
identifying the first individual based on analyzing the one or more images using at least on facial recognition model.

17. The system of claim 15, the method further comprising:
receiving second purchase data, wherein the second purchase data indicates a third item purchased by a third individual;
determining that the third item is included in the predefined list of reactants;
determining that the second purchase data is not suspicious; and
refraining from generating an alert indicating the third individual.

18. The system of claim 17, wherein determining that the second purchase data is not suspicious comprises:
analyzing purchase data associated with the third individual to identify one or more other items purchased by third individual; and
determining that the third item and at least one of the one or more other items are both included in a predefined legitimate combination.

19. The system of claim 17, wherein determining that the second purchase data is not suspicious comprises:
analyzing at least one social media platform associated with the third individual to identify a first attribute of the third individual; and
determining that the first attribute and the third item are both included in a predefined legitimate use.

20. The system of claim 15, wherein identifying the plurality of other individuals that have a known relationship with the first individual comprises evaluating at least one social media platform to identify at least one of: (i) a friendship or association between the first individual and at least one of the plurality of other individuals, or (ii) a group to which the first individual and at least one of the plurality of other individuals belong.
